(19) United States
(12) Patent Application Publication
(10) Pub. No.: US 2017/0252963 A1
(43) Pub. Date: Sep. 7, 2017

(54) OPTICAL SHEET MANUFACTURING DEVICE AND MANUFACTURING METHOD

(71) Applicant: NIPPON CARBIDE INDUSTRIES CO., INC., Minato-ku, Tokyo (JP)

(72) Inventors: Ikuo Mimura, Uozu-shi (JP); Chihiro Hayashi, Namerikawa-shi (JP)

(21) Appl. No.: 15/505,969

(22) PCT Filed: Aug. 21, 2015
(86) PCT No.: PCT/JP2015/073499

§ 371 Date: Feb. 23, 2017

(30) Foreign Application Priority Data
Aug. 29, 2014 (JP) 2014-176451

(51) Int. Cl. B29C 59/04; B29C 43/52; G02B 5/02

(52) U.S. Cl. CPC B29C 59/046; G02B 5/0215; B29C 43/52; G02B 5/02; B29C 2043/522; B29C 2043/527; B29K 2995/0018; B29K 2995/003; B29C 59/02

(57) ABSTRACT

A manufacturing device for an optical sheet according to the present invention includes a first belt 34 extending on a first heating roll 31 and a first chill roll 32 and a second belt 44 extending on a second heating roll 41 and a second chill roll 42. The first heating roll 31 presses, from the surface of the second belt 44, a second belt non-contact portion PT2 of the second belt 44 facing the first belt 34 where the second heating roll 41 is not in contact with the second chill roll 42. The second chill roll 42 presses, from the surface of the first belt, a first belt non-contact portion PT1 of the first belt 34 facing the second belt 44 where the first heating roll 31 is not in contact with the first chill roll 32.

### TECHNICAL FIELD

The present invention relates to a manufacturing device and a manufacturing method for an optical sheet, which are suitable for the case of manufacturing an optical sheet whose parameters are much closer to design values.

### BACKGROUND ART

Heretofore, as sheets having various optical functions, optical sheets are used, in which an aggregate of micro optical elements is formed on the surface of a resin sheet. In such optical sheets, the accuracy of the shape of the optical elements greatly affects the performance of the optical sheet. Thus, it is requested to manufacture an optical sheet with parameters much closer to design values.

As a manufacturing method for an optical sheet, Patent Literature 1 below is disclosed. In the manufacturing method of Patent Literature 1 below, an emboss belt (20) looped around drive rolls (21 and 22) is opposed to a pressure belt (30) looped around drive rolls (31 and 33), and a thermoplastic resin sheet (60) is supplied between these belts. An irregular shape formed on the emboss belt (20) is transferred onto the surface of the thermoplastic resin sheet (60).

A partial pressure roll (40) is provided in a section from the drive rolls (21 and 31) opposed in the previous stage to the drive rolls (22 and 33) opposed in the subsequent stage. The partial pressure roll (40) is movable so as to change pressing force applied to the emboss belt (20) and the pressure belt (30).
[Patent Literature 1] JP-A-H08-207137

### SUMMARY OF INVENTION

However, in the manufacturing method of Patent Literature 1 above, a tendency is observed in which in the section from the drive rolls (21 and 31) in the previous stage to the drive rolls (22 and 33) in the subsequent stage, the emboss belt (20) and the pressure belt (30) are bent, and the emboss belt (20) is separated from the pressure belt (30), which have been in contact with each other through the thermoplastic resin sheet (60), and hence this causes the displacement of the relative position. The following is the reason for this displacement. The emboss belt (20) is not in contact with the pressure belt (30) in a belt portion between the partial pressure roll (40) and the drive rolls (21 and 31) opposed to each other in the previous stage and a belt portion between the partial pressure roll (40) and the opposed part of the drive rolls (22 and 33) opposed to each other in the subsequent stage. Thus, in these belt portions, pressing stresses given to each other between the emboss belt (20) and the pressure belt (30) become weak.

As described above, in the manufacturing method of Patent Literature 1 above, a tendency is observed in which the relative position between the belts is displaced to degrade the transferability of optical elements. Thus, it is demanded to find a manufacturing device and a manufacturing method that can manufacture an optical sheet with parameters much closer to design values.

Therefore, an object of the present invention is to provide a manufacturing device and a manufacturing method for an optical sheet that can manufacture an optical sheet with parameters much closer to design values.

To solve the problem, a manufacturing device for an optical sheet of the present invention includes: a first belt having a surface formed with a forming die in a predetermined shape, the first belt extending on a first heating roll and a first chill roll, the first belt being moved corresponding to rotation of the first heating roll and the first chill roll; and a second belt having a surface formed with a forming die in a predetermined shape, the second belt extending on a second heating roll and a second chill roll, the second belt being moved corresponding to rotation of the second heating roll and the second chill roll.

In addition, the first heating roll is disposed opposed to the second heating roll; the first chill roll is disposed opposed to the second chill roll; the first belt is disposed opposed to the second belt so that a surface of the first belt faces a surface of the second belt;

the first heating roll is disposed pressing, from the surface of the second belt, a second belt non-contact portion that is a belt portion of the second belt facing the first belt where the second heating roll and the second chill roll are not in contact with the second belt;

the second belt non-contact portion meanders along the first heating roll so as to bend to center sides of the second heating roll and the second chill roll from a tangential plane between the second heating roll and the second chill roll;

the second chill roll is disposed pressing, from the surface of the first belt, a first belt non-contact portion that is a belt portion of the first belt facing the second belt where the first heating roll and the first chill roll are not in contact with the first belt;

the first belt non-contact portion meanders along the second chill roll so as to bend to center sides of the first heating roll and the first chill roll from a tangential plane between the first heating roll and the first chill roll; and

a forming resin is supplied between a surface of a belt portion of the first belt where the first belt is in contact with the first heating roll and a surface of a belt portion of the second belt where the second belt is in contact with the second heating roll, pressed by the two surfaces, and conveyed being sandwiched by the first belt and the second belt to a subsequent stage.

On the other hand, a manufacturing method for an optical sheet of the present invention includes: a resin supplying process of supplying a forming resin between a first belt and a second belt, the first belt extending on a first heating roll and a first chill roll, the first belt being moved corresponding to rotation of the first heating roll and the first chill roll, the second belt extending on a second heating roll facing the first heating roll and a second chill roll facing the first chill roll, the second belt being moved corresponding to rotation of the second heating roll and the second chill roll; an embossing process of softening the forming resin using the first heating roll and the second heating roll and forming optical elements on the forming resin using a forming die formed on a surface of the first belt and a forming die formed on a surface of the second belt; and a cooling process of cooling the forming resin formed with the optical elements using the first chill roll and the second chill roll.

In addition, the first heating roll is disposed pressing, from the surface of the second belt, a second belt non-contact portion that is a belt portion of the second belt facing the first belt where the second heating roll and the second chill roll are not in contact with the second belt;

the second belt non-contact portion meanders along the first heating roll so as to bend to center sides of the second heating roll and the second chill roll from a tangential plane between the second heating roll and the second chill roll;

the second chill roll is disposed pressing, from the surface of the first belt, a first belt non-contact portion that is a belt portion of the first belt facing the second belt where the first heating roll and the first chill roll are not in contact with the first belt;

the first belt non-contact portion meanders along the second chill roll so as to bend to center sides of the first heating roll and the first chill roll from a tangential plane between the first heating roll and the first chill roll; and

a forming resin is supplied between a surface of a belt portion of the first belt where the first belt is in contact with the first heating roll and a surface of a belt portion of the second belt where the second belt is in contact with the second heating roll, pressed by the two surfaces, and conveyed being sandwiched by the first belt and the second belt to a subsequent stage.

As described above, according to the present invention, the first heating roll is disposed pressing the second belt from the surface of the second belt. The second chill roll is disposed pressing the first belt facing the second belt from the surface of the first belt. No other pressure rolls are provided between these two rolls. That is, the first heating roll can be made closer to the second chill roll because no other pressure rolls are provided, and tension can be applied to the first belt and the second belt. Thus, the region of the belt portion separated from the first heating roll and the second chill roll can be made as small as possible while tension is applied to the belt portion between these rolls. Therefore, according to the present invention, the displacement of the relative position between the first belt and the second belt can be reduced, which is caused by a bend in the belt portion between the first heating roll and the second chill roll to separate the first belt from the second belt that has been in contact with the first belt through the forming resin. Consequently, the optical sheet with parameters much closer to design values can be obtained.

Preferably, the forming resin conveyed to the subsequent stage is conveyed to a belt portion of the second belt where the second belt is in contact with the second chill roll, cooled, released from the surface of the first belt, and conveyed being attached to the surface of the second belt to a subsequent stage.

In the case of providing this configuration, the forming resin is released from the first belt along the meandering direction of the first belt. Thus, the forming resin can be easily released from the surface of the belt, compared with the case in which the forming resin is released from the second belt resisting the meandering direction of the first belt.

Preferably, the second chill roll is disposed pressing the first chill roll through the second belt, the forming resin, and the first belt.

In such a disposition state, the first chill roll faces the second chill roll at positions closest to each other sandwiching the second belt, the forming resin, and the first belt. Thus, the first belt portion and the second belt portion between the first chill roll and the second chill roll are in contact with any one of the rolls with the absent of non-contact portions. Therefore, the displacement of the relative position between the first belt portion and the second belt portion present between the first chill roll and the second chill roll can be prevented. Consequently, the optical sheet with parameters much closer to design values can be obtained.

Preferably, the first heating roll is disposed pressing the second chill roll through the first belt, the forming resin, and the second belt.

In such a disposition state, the first heating roll faces the second chill roll at positions closest to each other sandwiching the first belt, the forming resin, and the second belt. Thus, the first belt portion and the second belt portion between the first heating roll and the second chill roll are in contact with any one of the rolls with the absent of non-contact portions. Therefore, the displacement of the relative position between the first belt portion and the second belt portion present between the first heating roll and the second chill roll can be prevented. Consequently, the optical sheet with parameters much closer to design values can be obtained.

Preferably, a surface temperature of the first heating roll is lower than a surface temperature of the second heating roll.

In the case of providing this configuration, in the first heating roll and the second heating roll, the surface temperature of the first heating roll closer to the chill rolls is low. Thus, the surface of the first belt in contact with the first heating roll and the surface of the second belt in contact with the first heating roll through another member can be quickly cooled by the chill rolls in the subsequent stage, and the forming resin can be easily released from the first belt or the surface of the second belt, compared with the case in which the surface temperatures of the first heating roll and the second heating roll are almost the same.

Preferably, a surface temperature of the first chill roll is lower than a surface temperature of the second chill roll.

In the case of providing this configuration, in the first chill roll and the second chill roll, the surface temperature of the first chill roll, at which the forming resin is released from the belt, is low. Thus, the surface of the first belt, from which the forming resin has to be released, can be quickly cooled, and the forming resin can be easily released from the surface of the first belt, compared with the case in which the surface temperatures of the first chill roll and the second chill roll are almost the same.

Preferably, the forming die on the surface of the first belt is in a flat shape or an irregular shape, and the forming die on the surface of the second belt is in an irregular shape, and a height difference of irregularities of the first belt is smaller than a height difference of irregularities of the second belt.

In the case of providing this configuration, in the first belt and the second belt, the height difference of the irregularities of the first belt, from which the forming resin is released, is small. Thus, the forming resin can be easily released from the surface of the first belt, compared with the case in which the height differences of the irregularities of the first belt and the second belt are almost the same.

As described above, according to the present invention, there are provided a manufacturing device for an optical sheet and a manufacturing method for an optical sheet that can manufacture an optical sheet with parameters much closer to design values.

### BRIEF DESCRIPTION OF DRAWINGS

FIG. 1 is a cross-sectional view of an exemplary optical sheet according to a first embodiment.

FIG. 2 is a diagram of a manufacturing device for an optical sheet according to the first embodiment.

FIG. 3 is a diagram schematically illustrating a first transfer unit and a second transfer unit according to the first embodiment when viewed from the side surface direction.

FIG. 4 is a flowchart of a manufacturing method for an optical sheet according to the first embodiment.

FIG. 5 is a cross-sectional view of an exemplary optical sheet according to a second embodiment.

FIG. 6 is a diagram schematically illustrating a first transfer unit and a second transfer unit according to the second embodiment when viewed from the same perspective as in FIG. 3.

FIG. 7 is a flowchart of a manufacturing method for an optical sheet according to the second embodiment.

### DESCRIPTION OF EMBODIMENTS

Preferred embodiments for implementing the present invention will be described in detail with reference to the drawings.

### (1) First Embodiment

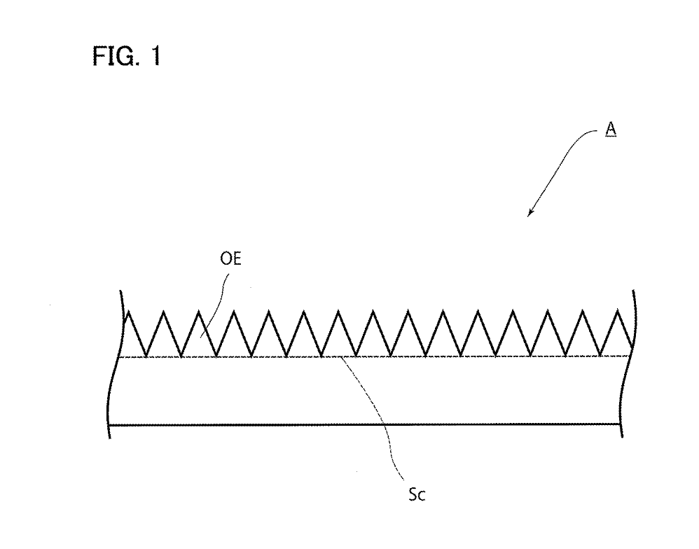

FIG. 1 is a cross-sectional view of an exemplary optical sheet according to a first embodiment. As illustrated in FIG. 1, an optical sheet A according to the embodiment is formed of a transparent resin. A large number of optical elements OE are formed on one surface. The optical element OE is a columnar triangular prism. In the case of the embodiment, the columnar triangular prisms are disposed on a common plane Sc.

The optical element OE described above has properties that condense light entered from one of the surfaces of the optical sheet A, which is the surface located on the opposite side of the optical elements OE, on the outer side of the optical elements OE, and then emit the light. Note that, the height of the optical element OE (the height from the common plane Sc) is not limited specifically. However, in order to obtain excellent optical properties, the height is preferably in a range of 0.5 to 200 μm, and more preferably in a range of 7 to 70 μm.

Any resins of excellent transparency can be used for a resin forming the optical sheet A. Examples of resins include acrylic resins, polyester resins, polycarbonate resins, vinyl chloride resins, polystyrene resins, polyolefin resins, fluorine resins, cyclic olefin resins, silicone resins, polyurethane resins, and the like, or combinations of these resins. Note that, from the viewpoints of weather resistance, transparency, and other properties, acrylic resins, polycarbonate resins, vinyl chloride resins, and polyurethane resin are preferable.

Note that, a resin forming the optical sheet A may be mixed with any one of a plasticizer, an antioxidant, an ultraviolet absorption agent, an antistatic agent, a fire retardant, a fungicide, a slip additive, a coloring agent, a crosslinker, an impact modifier, a filler, a dispersing agent, or inorganic fine particles, for example, or a plurality of these agents.

Next, a manufacturing device for the optical sheet described above will be described.

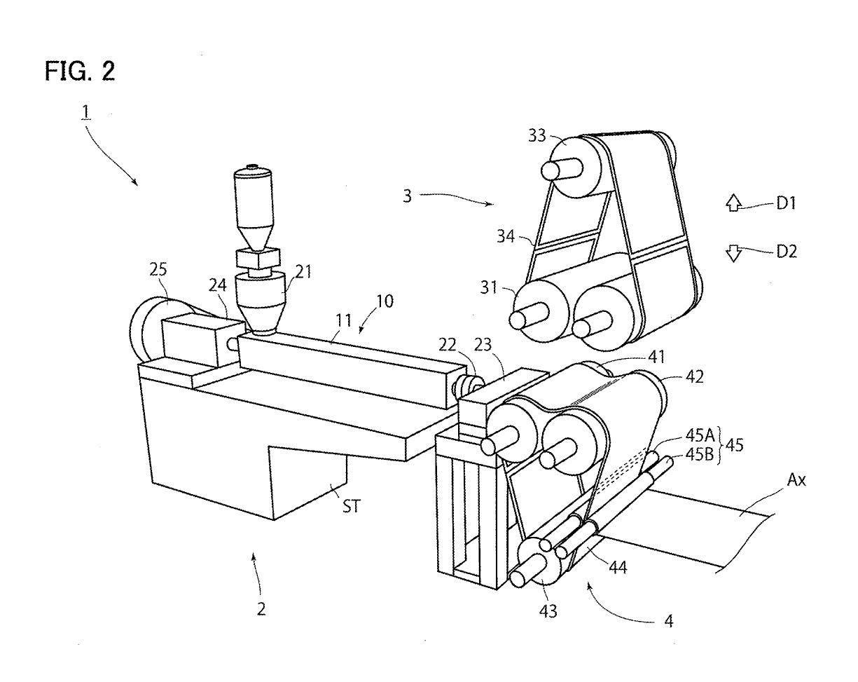

FIG. 2 is a diagram of a manufacturing device 1 for the optical sheet A according to the first embodiment. As illustrated in FIG. 2, the manufacturing device 1 for the optical sheet A according to the embodiment includes, as main components, a resin supply unit 2, a first transfer unit 3, and a second transfer unit 4.

The resin supply unit 2 includes an extruder 10 provided on a mounting stage ST. On one end of a cylinder 11 of the extruder 10, which is the upstream side of the cylinder 11, a raw material supply hopper 21 is provided. On the other end, which is the downstream side of the cylinder 11, a dice 23 is provided through a die adapter 22.

In the inside of the cylinder 11, a screw, such as a single-spindle or two-spindle screw, is provided. To the screw, a rotary motor 25 is joined through a rotation speed controller 24.

The extruder 10 conveys a raw material supplied from the raw material supply hopper 21 to the downstream side by rotating the screw, and melts and kneads the raw material. The extruder 10 extrudes a molten resin obtained by kneading the raw material as a forming resin Ax in turn through the die adapter 22 and the dice 23 for forming the forming resin Ax in a sheet.

Note that, the raw material delivered from the raw material supply hopper 21 into the inside of the cylinder 11 is not limited specifically. However, examples of the raw material include examples of the materials of the resins forming the optical sheet A.

The first transfer unit 3 includes a first heating roll 31, a first chill roll 32, a first extension roll 33, and a first belt 34.

The first heating roll 31 is in a nearly columnar shape, and is configured to rotate about a shaft. At least the surface of the first heating roll 31 is heated.

Note that, examples of the heating mechanism of the first heating roll 31 include, for example, an internal heating mechanism that heats the first heating roll 31 from the inside and an external heating mechanism that heats the first heating roll 31 from the outside. Specific examples of the internal heating mechanism include heat generators that generate heat by dielectric heating, heating medium circulating, and other methods. Specific examples of the external heating mechanism include a hot air blaster, a near-infrared lamp heater, a far-infrared lamp heater, and other devices. A configuration may be possible in which when the first heating roll 31 is heated using the internal heating mechanism described above, the external heating mechanism is used as an auxiliary device. The temperature of the surface of the first heating roll 31 is appropriately selected suitable for the glass transition temperature of the optical sheet A, the thickness of the optical sheet A, the shape of the optical element OE, and other parameters.

The first chill roll 32 is in a nearly columnar shape, and is configured to rotate about a shaft. At least the surface of the first chill roll 32 is cooled.

Note that, examples of the cooling mechanism of the first chill roll 32 include, for example, an internal cooling mechanism that cools the first chill roll 32 from the inside. Specific examples of the internal cooling mechanism include, for example, a circulating cooling device that circulates a cooling medium, such as water, in the inside of the first chill roll 32 for cooling. As with the first heating roll 31, the temperature of the surface of the first chill roll 32 is appropriately selected suitable for the glass transition temperature of the optical sheet A, the thickness of the optical sheet A, the shape of the optical element OE, and other parameters.

The first extension roll 33 is a roll for maintaining the state of the first belt 34 extending on the first heating roll 31 and the first chill roll 32 with no looseness. As with the first heating roll 31 and the first chill roll 32, the first extension roll 33 is in a nearly columnar shape and configured to rotate about a shaft.

The first belt 34 is looped around the first heating roll 31, the first chill roll 32, and the first extension roll 33, and moved corresponding to the rotation of the rolls 31 to 33. A large number of forming dies in a predetermined shape are continuously formed on the surface of the first belt 34. Specifically, the forming die is a forming die for the optical element OE. The forming die has irregularities that have to be formed on the surface of the optical sheet A. Note that, for convenience, in FIG. 2, the forming dies formed on the surface of the first belt 34 are omitted.

Note that, the thickness of the first belt 34 is not limited specifically. However, the thickness is preferably 1/3000 to 1/500 of the diameter of the first heating roll 31, and more preferably 1/1200 to 1/800 of the diameter of the first heating roll 31.

The second transfer unit 4 includes a second heating roll 41, a second chill roll 42, a second extension roll 43, a second belt 44, and a release roll 45.

The second heating roll 41 has a configuration similar to the configuration of the first heating roll 31. The second chill roll 42 has a configuration similar to the configuration of the first chill roll 32. The second extension roll 43 has a configuration similar to the configuration of the first extension roll 33.

The second belt 44 is looped around the second heating roll 41, the second chill roll 42, and the second extension roll 43, and moved corresponding to the rotation of the rolls 41 to 43. The surface of the second belt 44 is a forming die for a flat optical element with no irregularities. Note that, in the specification, the term “flat face” means that the average roughness of the surface is 50 nm or less.

The release roll 45 includes a first release roll 45A disposed between the second chill roll 42 and the second extension roll 43 and a second release roll 45B disposed facing the first release roll 45A through the second belt 44. The first release roll 45A and the second release roll 45B are rolls that release the sheet-like forming resin Ax disposed on the forming die of the second belt 44 from the second belt 44. The rolls are in a nearly columnar shape, and configured to rotate about shafts. Note that, the rotation direction of the first release roll 45A is inverted to the rotation direction of the second release roll 45B.

The first and the second transfer units 3 and 4 thus configured are relatively movable in the direction in which they are apart from each other and in the direction in which they approach each other. In the case of the embodiment, the second transfer unit 4 is fixed, the first transfer unit 3 is movable in a direction D1 in which the first transfer unit 3 is apart from the second transfer unit 4 and a direction D2 in which the first transfer unit 3 approaches the second transfer unit 4. Note that, FIG. 2 shows the state in which when the optical sheet is not manufactured, the first transfer unit 3 is disposed at a predetermined preparation position at which the first transfer unit 3 has to be disposed.

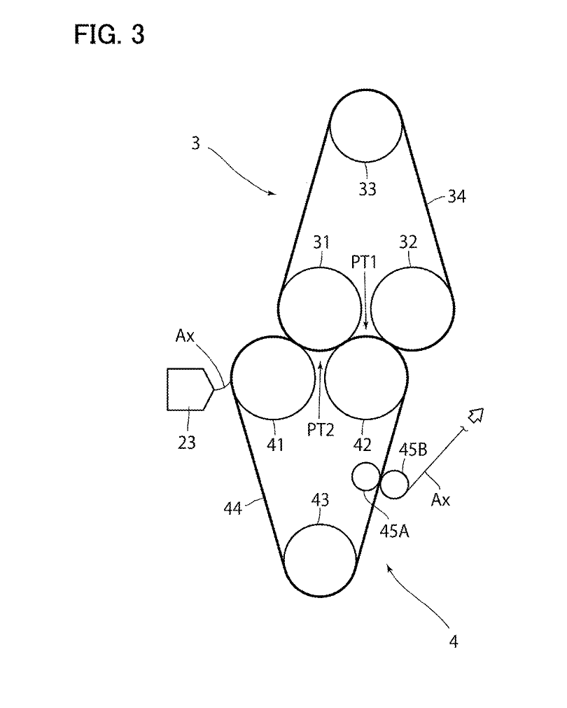

FIG. 3 is a diagram schematically illustrating the first and the second transfer units 3 and 4 according to the first embodiment when viewed from the side surface direction. Specifically, FIG. 3 schematically illustrates the first and the second transfer units 3 and 4 when viewed from the direction along the shafts of the rolls of the first and the second transfer units 3 and 4 with the side surfaces of the rolls being on the front side. Note that, FIG. 3 illustrates the state in which in manufacturing the optical sheet, the first transfer unit 3 is disposed at a predetermined position at which the first transfer unit 3 has to be disposed. For convenience, the shafts of the rolls of the first and the second transfer units 3 and 4 are omitted.

As illustrated in FIG. 3, in the case in which the first transfer unit 3 is disposed at the position at which the optical sheet is manufactured, tension is applied to predetermined portions of the first belt 34 of the first transfer unit 3 and the second belt 44 of the second transfer unit 4.

That is, the first heating roll 31 is disposed being oppositely spaced at a predetermined distance to the second heating roll 41, and the first chill roll 32 is disposed being oppositely spaced at a predetermined distance to the second chill roll 42.

The first belt 34 is disposed opposed to the second belt 44 so that the die forming face of the first belt 34 faces the die forming face of the second belt 44. Note that, the term “die forming face” means the surface on which the forming die is formed.

The first heating roll 31 is disposed pressing, from the die forming face side of the second belt 44, a second belt non-contact portion PT2, which is the belt portion of the second belt 44 facing the first belt 34 where the second heating roll 41 and the second chill roll 42 are not in contact with the second belt 44.

In the case of the embodiment, the first heating roll 31 presses the second heating roll 41 and the second chill roll 42 through the first belt 34, the forming resin Ax, and the second belt 44. That is, the first heating roll 31 faces the second heating roll 41 and the first heating roll 31 faces the second chill roll 42 at positions closest to each other sandwiching the first belt 34, the forming resin Ax, and the second belt 44.

Such press of the first heating roll 31 imparts tension to the second belt non-contact portion PT2. When tension is applied, the second belt non-contact portion PT2 meanders along the first heating roll 31 so as to bend to the center sides of the second heating roll 41 and the second chill roll 42 from the tangential plane between the rolls 41 and 42.

Note that, the second belt non-contact portion PT2 is also regarded as a belt portion in a section from a position at which the second belt 44 moving in the rotation directions of the second heating roll 41 and the second chill roll 42 starts to leave the second heating roll 41 and a position immediately before the second belt 44 to start to contact the second chill roll 42.

The second chill roll 42 is disposed pressing, from the die forming face side of the first belt 34, a first belt non-contact portion PT1, which is the belt portion of the first belt 34 facing the second belt 44 where the first heating roll 31 and the first chill roll 32 are not in contact with the first belt 34.

In the case of the embodiment, the second chill roll 42 is disposed pressing the first chill roll 32 in turn through the second belt 44, the forming resin Ax, and the first belt 34. That is, the first chill roll 32 faces the second chill roll 42 at positions closest to each other sandwiching the first belt 34, the forming resin Ax, and the second belt 44 with no gap.

Such press of the second chill roll 42 imparts tension to the first belt non-contact portion PT1. When tension is applied, the first belt non-contact portion PT1 meanders along the second chill roll 42 so as to bend to the center sides of the first heating roll 31 and the first chill roll 32 from the tangential plane between the rolls 31 and 32.

Note that, the first belt non-contact portion PT1 is also regarded as the belt portion in a section between a position at which the first belt 34 moving in the rotation directions of the first heating roll 31 and the first chill roll 32 starts to leave the first heating roll 31 and a position immediately before the first belt 34 to start to contact the first chill roll 32.

As described above, tension is applied to predetermined portions of the first belt 34 of the first transfer unit 3 and the second belt 44 of the second transfer unit 4 at the positions at which the optical sheet is manufactured.

The forming resin Ax extruded from the dice 23 of the extruder 10 is extruded from the dice 23 to the region of the second belt 44 in contact with the second heating roll 41, and is formed in a sheet shape.

The forming resin Ax is supplied between the die forming face of the first belt 34 in contact with the first heating roll 31 and the die forming face of the second belt 44 in contact with the second heating roll 41, and is pressed by the two surfaces.

After that, the forming resin Ax is conveyed being sandwiched by the first belt 34 and the second belt 44 to the belt portion where the second belt 44 is in contact with the second chill roll 42, and cooled by the second chill roll 42 from the second belt 44 side.

Subsequently, the forming resin Ax is conveyed to the belt portion where the first belt 34 is in contact with the first chill roll 32, and cooled by the first chill roll 32 from the first belt 34 side.

The forming resin Ax is released from the surface of the first belt 34, conveyed being attached to the surface of the second belt 44 to the subsequent stage, released from the surface of the second belt 44 by the release roll 45, and wound on a reel, not shown.

Next, a manufacturing method for the optical sheet A using the manufacturing device 1 described above will be described.

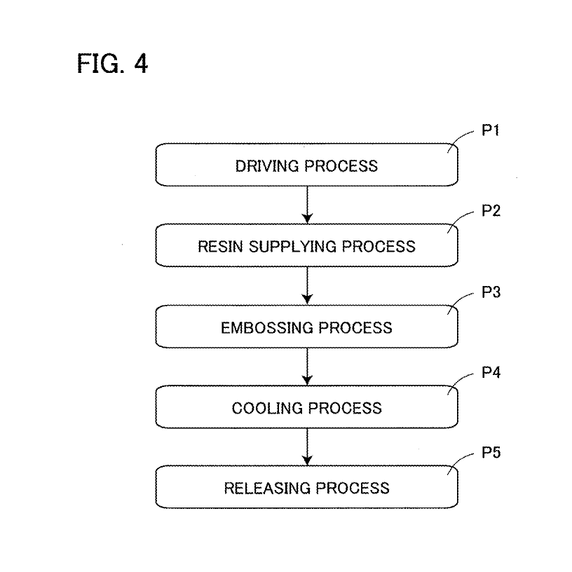

FIG. 4 is a flowchart of a manufacturing method for the optical sheet A. As illustrated in FIG. 4, a manufacturing method for an optical sheet according to the embodiment includes a driving process P1, a resin supplying process P2, an embossing process P3, a cooling process P4, and a releasing process P5 as main processes. Note that, in the embodiment, the processes sometimes partially simultaneously proceed.

<Driving Process P1>

The driving process P1 is a process that drives the resin supply unit 2 and the first and the second transfer units 3 and 4. That is, in the process, the state is prepared in which the first transfer unit 3 is moved from a predetermined preparation position to the position at which the optical sheet is manufactured, and tension is applied to the predetermined portions of the first belt 34 of the first transfer unit 3 and the second belt 44 of the second transfer unit 4. Note that, the disposition relationship between the first heating roll 31, the first chill roll 32, and the first belt 34 of the first transfer unit 3 and the disposition relationship between the second heating roll 41, the second chill roll 42, and the second belt 44 of the second transfer unit 4 in this state are described above, and hence the description is omitted.

In the first transfer unit 3, the first heating roll 31, the first chill roll 32, and the first extension roll 33 are driven, and the rolls are rotated in the same direction. Thus, the first belt 34 is moved around the first heating roll 31, the first chill roll 32, and the first extension roll 33 in a set traveling direction.

A predetermined heating mechanism of the first heating roll 31 is driven to heat at least the surface of the first heating roll 31. Thus, on the first belt 34 moving in the set traveling direction, the region in contact with the first heating roll 31 is heated.

A predetermined cooling mechanism of the first chill roll 32 is driven to cool at least the surface of the first chill roll 32. Thus, on the first belt 34 moving in the set traveling direction, the region in contact with the first chill roll 32 is cooled.

In the second transfer unit 4, the second heating roll 41, the second chill roll 42, and the second extension roll 43 are driven, and the rolls are rotated in the reverse directions of the rotation directions of the rolls 31 to 33 of the first transfer unit 3. Thus, the second belt 44 is moved around the second heating roll 41, the second chill roll 42, and the second extension roll 43 in the traveling direction the same as the traveling direction of the first belt 34.

A predetermined heating mechanism of the second heating roll 41 is driven to heat at least the surface of the second heating roll 41. Thus, on the second belt 44 moving in the set traveling direction, the region in contact with the second heating roll 41 is heated.

A predetermined cooling mechanism of the second chill roll 42 is driven to cool at least the surface of the second chill roll 42. Thus, on the second belt 44 moving in the set traveling direction, the region in contact with the first chill roll 32 is cooled.

The first release roll 45A is driven so as to rotate in a rotation direction the same as the rotation direction of the second heating roll 41. The second release roll 45B is driven so as to rotate in a rotation direction reverse to the rotation direction of the first release roll 45A.

In the resin supply unit 2, the rotary motor 25 is driven to rotate the screw provided in the cylinder 11 of the extruder 10. The rotation speed controller 24 is driven to adjust the rotation speed of the screw.

<Resin Supplying Process P2>

The resin supplying process P2 is a process that supplies the sheet-like forming resin Ax between the first belt 34 and the second belt 44. That is, a raw material is started to be supplied from the raw material supply hopper 21 of the resin supply unit 2 to the inside of the cylinder 11 of the extruder 10. Thus, the raw material is molten and kneaded by rotating the screw in the cylinder 11, and is formed into the sheet-like forming resin Ax by the dice 23 joined to the cylinder 11 through the die adapter 22. The forming resin Ax is extruded from the dice 23 to the region of the second belt 44 in contact with the second heating roll 41, and supplied between the first heating roll 31 and the second heating roll 41 by moving the second belt 44 in the traveling direction.

<Embossing Process P3>

The embossing process P3 is a process that softens the forming resin Ax and forms the optical elements OE on the surface. That is, the forming resin Ax supplied between the first heating roll 31 and the second heating roll 41 is sandwiched by the first belt 34 and the second belt 44. At this time, the temperature of the forming resin Ax is increased to the glass transition temperature or more by heat applied from the first heating roll 31 through the first belt 34 and heat applied from the second heating roll 41 through the second belt 44, and the forming resin Ax is softened. At the same time, with the application of the pressing force of the first heating roll 31 to the forming resin Ax, the forming resin Ax is compression bonded to the die forming face of the first belt 34 and the die forming face of the second belt 44, and the optical elements OE are formed on the surface of the forming resin Ax.

Note that, the viscosity when the forming resin Ax is softened is 10,000 PaS (100,000 poises) or less, and preferably 5,000 PaS (50,000 poises) or less. The pressing force of the first heating roll 31 depends on the type of the forming resin Ax, the shape of the forming die formed on the die forming face of the first belt 34 or the second belt 44, and the other parameters, which are not limited specifically. However, the pressing force is preferably in a renege of 5 to 100 kg/cm to the width of the forming resin Ax, and more preferably in a renege of 10 to 80 kg/cm. The rates of travel of the first belt 34 and the second belt 44 are not limited specifically. However, the rates of travel are preferably in a range of 1 to 20 m/min, and more preferably in a range of 2 to 10 m/min.

<Cooling Process P4>

The cooling process P4 is a process that cools the forming resin Ax formed with the optical elements OE. That is, the forming resin Ax is reached between the first chill roll 32 and the second chill roll 42 being sandwiched by the first belt 34 and the second belt 44 present between the first heating roll 31 and the second heating roll 41. At this time, with the application of the pressing force of the second chill roll 42 to the forming resin. Ax, the forming resin Ax is compression bonded to the die forming face of the first belt 34 and the die forming face of the second belt 44. In this state, the forming resin Ax is cooled by both the first chill roll 32 and the second chill roll 42 through the first belt 34 and the second belt 44.

<Releasing Process P5>

In the releasing process P5, the forming resin Ax sandwiched by the first belt 34 and the second belt 44 is released from one of the first belt 34 and the second belt 44. In the embodiment, the forming resin Ax is released from the surface of the first belt 34 being attached to the surface of the second belt 44, conveyed in the traveling direction of the second belt 44, and released from the surface of the second belt 44 by the release roll 45. After that, the forming resin Ax is wounded on the reel, not shown, and subjected to processing, such as cutting, and then the optical sheet A as illustrated in FIG. 1 is obtained.

As described above, in the embodiment, the first heating roll 31 is disposed pressing the second belt 44 from the surface side of the second belt 44, and the second chill roll 42 is disposed pressing the first belt 34 opposed to the second belt 44 from the surface side of the first belt 34. No other pressure rolls are provided between the first heating roll 31 and the second chill roll 42.

That is, the first heating roll 31 can be made closer to the second chill roll 42, because the other pressure rolls are not provided, and tension can be applied to the first belt 34 and the second belt 44. Consequently, the region of the belt portion separated from the rolls can be made as small as possible while tension is applied to the belt portion between the first heating roll 31 and the second chill roll 42. Therefore, according to the manufacturing device 1 and the manufacturing method of the embodiment, the displacement of the relative position between the first belt and the second belt can be reduced, which is caused by a bend in the belt portion between the first heating roll 31 and the second chill roll 42 to separate the first belt from the second belt that has been in contact with the first belt through the forming resin Ax. Consequently, the optical sheet A with parameters much closer to design values can be obtained.

In the case of the embodiment, the first heating roll 31 is disposed pressing the second chill roll 42 through the first belt 34, the forming resin Ax, and the second belt 44.

In such a disposition state, the first heating roll 31 faces the second chill roll 42 at positions closest to each other sandwiching the first belt 34, the forming resin Ax, and the second belt 44. Thus, the belt portions of the first belt 34 and the second belt 44 between the first heating roll 31 and the second chill roll 42 are in contact with any one of the rolls with the absent of non-contact portions. Therefore, the displacement of the relative position between the belt portions of the first chill roll 32 and the second chill roll 42 can be prevented. Consequently, the optical sheet A with parameters much closer to design values can be obtained.

In the case of the embodiment, the second chill roll 42 is disposed pressing the first chill roll 32 through the second belt 44, the forming resin Ax, and the first belt 34.

In such a disposition state, the first chill roll 32 faces the second chill roll 42 at positions closest to each other sandwiching the first belt 34, the forming resin Ax, and the second belt 44. Thus, the belt portions of the first belt 34 and the second belt 44 between the first chill roll 32 and the second chill roll 42 are in contact with any one of the rolls with the absent of non-contact portions. Therefore, the displacement of the relative position between the belt portions of the first chill roll 32 and the second chill roll 42 can be prevented. Consequently, the optical sheet A with parameters much closer to design values can be obtained.

Note that, the forming resin Ax according to the embodiment is conveyed to the belt portion where the second belt 44 is in contact with the second chill roll 42 and cooled, and the forming resin Ax is released from the surface of the first belt 34, and conveyed being attached to the surface of the second belt 44.

Accordingly, the forming resin Ax is released from the first belt 34 along the meandering direction of the first belt 34. Thus, the forming resin can be easily released, compared with the case in which the forming resin is released from the second belt 44 resisting the meandering direction of the first belt 34.

In the case of the embodiment in which the first transfer unit 3 including the first heating roll 31 and the first chill roll 32 is movable, it is advantageous in that the configuration of the first transfer unit 3 on the moving side can be simplified.

### (2) Second Embodiment

Next, a second embodiment will be described in detail. However, components the same as or equivalent to the components of the first embodiment are designated the same reference numerals and signs, and the overlapping description is appropriately omitted.

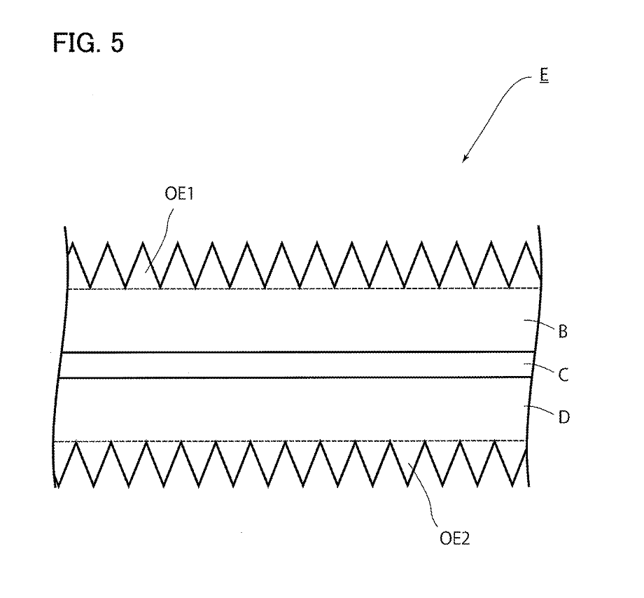

FIG. 5 is a cross-sectional view of an exemplary optical sheet according to the second embodiment. As illustrated in FIG. 5, an optical sheet E according to the embodiment is configured of a first optical layer B, a second optical layer C, and a third optical layer D in turn stacked.

A large number of optical elements OE1 are formed on the surface of the first optical layer B on the opposite side of the face opposed to the second optical layer C. A large number of optical elements OE2 are formed on the surface of the third optical layer D on the opposite side of the face opposed to the second optical layer C. Note that, the shapes and sizes of the optical element OE1 and OE2 may be the same or different.

Examples of resins forming the first optical layer B, the second optical layer C, and the third optical layer D include the resins described in the first embodiment, for example, and these resins are appropriately mixed with a plasticizer and other agents, as with the first embodiment.

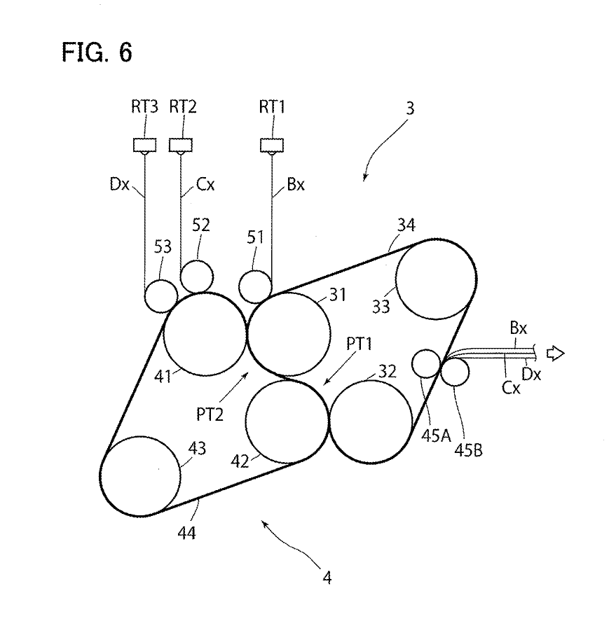

Next, referring to FIG. 6, a manufacturing device for the optical sheet E according to the embodiment will be described. FIG. 6 is a diagram schematically illustrating a first transfer unit and a second transfer unit according to the second embodiment when viewed from the same perspective as in FIG. 3.

As illustrated in FIG. 6, the manufacturing device according to the embodiment is different from the manufacturing device 1 according to the first embodiment in that sheet supply reels RT1 to RT3 are provided instead of the resin supply unit 2 of the first embodiment.

The sheet supply reels RT1 to RT3 deliver forming resins Bx to Dx in a solid sheet shape. Note that, the forming resin Bx delivered from the sheet supply reel RT1 is a resin sheet to be a first optical layer B, the forming resin Cx delivered from the sheet supply reel RT2 is a resin sheet to be a second optical layer C, and the forming resin Dx delivered from the sheet supply reel RT3 is a resin sheet to be a third optical layer D.

The manufacturing device according to the embodiment is different from the manufacturing device 1 according to the first embodiment in that a pressure roll 51 is newly provided on the first transfer unit 3 of the first embodiment and pressure rolls 52 and 53 are newly provided on the second transfer unit 4 of the first embodiment.

The pressure rolls 51 to 53 are made of rubber, for example, and the pressure rolls 51 to 53 are not provided with the heating mechanism of the first heating roll 31 or the second heating roll 41 and the cooling mechanism of the first chill roll 32 or the second chill roll 42.

The pressure roll 51 presses a predetermined region of the belt portion of the first belt 34 in contact with the first heating roll 31. Between the pressure roll 51 and the first belt 34, the forming resin Bx is supplied from the sheet supply reel RT1.

The pressure roll 52 presses a predetermined region of the belt portion of the second belt 44 in contact with the second heating roll 41. Between the pressure roll 52 and the second belt 44, the forming resin Cx is supplied from the sheet supply reel RT2.

In the belt portion of the second belt 44 in contact with the second heating roll 41, the pressure roll 53 presses a predetermined region in the reverse direction to the traveling direction of the second belt 44 from the pressure roll 52. Between the pressure roll 53 and the second belt 44, the forming resin Dx is supplied from the sheet supply reel RT3.

Note that, in the first embodiment, the surface of the second belt 44 is the forming die for the flat optical elements with no irregularities. However, in the case of the embodiment, a forming die for optical elements OE2 with irregularities is formed on the surface. As with the first embodiment, a forming die for the optical elements OE1 with irregularities is formed on the surface of the first belt 34. The first release roll 45A and the second release roll 45B are provided on the first transfer unit 3 in the first embodiment. However, in the embodiment, they are provided on the second transfer unit 4, which are changed from the first transfer unit 3. The forming resins Bx to Dx released from the first belt 34 by the first release roll 45A and the second release roll 45B are stacked with no gap. FIG. 6 illustrates the state in which for convenience, the forming resins Bx to Dx are separated from each other.

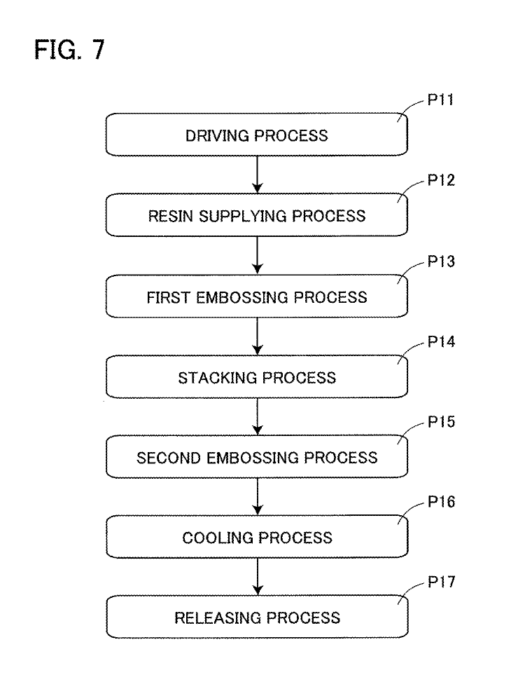

A manufacturing method for an optical sheet using the manufacturing device according to the embodiment thus configured is performed according to the procedures of a flowchart illustrated in FIG. 7. That is, as illustrated in FIG. 7, the manufacturing method for an optical sheet according to the embodiment includes a driving process P11, a resin supplying process P12, a first embossing process P13, a stacking process P14, a second embossing process P15, a cooling process P16, and a releasing process P17 as main processes. Note that, as with the first embodiment, the processes according to the embodiment sometimes partially simultaneously proceed.

<Driving Process P11>

The driving process P11 is a process that drives the first and the second transfer units 3 and 4. That is, as with the driving process P1 according to the first embodiment, the first and the second transfer units 3 and 4 are driven.

Specifically, the first transfer unit 3 is moved from a predetermined preparation position to the position at which the optical sheet is manufactured. The first heating roll 31, the first chill roll 32, the first extension roll 33, the first release roll 45A, and the second release roll 45B are driven, as well as a predetermined heating mechanism of the first heating roll 31 and a predetermined cooling mechanism of the first chill roll 32 are driven.

The second heating roll 41, the second chill roll 42, and the second extension roll 43 of the second transfer unit 4 are driven, as well as a predetermined heating mechanism of the second heating roll 41 and a predetermined cooling mechanism of the second chill roll 42 are driven.

<Resin Supplying Process P12>

The resin supplying process P12 is a process that supplies the forming resin Bx between the first belt 34 and the pressure roll 51 and supplies the forming resin Dx between the second belt 44 and the pressure roll 53.

That is, the forming resin Bx is delivered from the sheet supply reel RT1, and the forming resin is supplied between the first belt 34 and the pressure roll 51. The forming resin Dx is delivered from the sheet supply reel RT3, and the forming resin is supplied between the second belt 44 and the pressure roll 53.

<First Embossing Process P13>

The first embossing process P13 is a process that presses the die forming face of the first belt 34 to the surface of the forming resin Bx supplied between the first belt 34 and the pressure roll 51 and presses the die forming face of the second belt 44 to the surface of the forming resin Dx supplied between the second belt 44 and the pressure roll 53.

That is, the temperature of the forming resin Bx supplied between the first belt 34 and the pressure roll 51 is increased to the glass transition temperature or more by heat applied from the first heating roll 31 through the first belt 34, and the forming resin Bx is softened. At this time, with the application of the pressing force of the pressure roll 51 to the forming resin Bx, the forming resin Bx is compression bonded to the die forming face of the first belt 34, and the optical elements OE1 corresponding to the forming die of the first belt 34 are formed on the surface of the forming resin Bx.

In contrast, the temperature of the forming resin Dx supplied between the second belt 44 and the pressure roll 53 is increased to the glass transition temperature or more by heat applied from the second heating roll 41 through the second belt 44, and the forming resin Dx is softened. At this time, with the application of the pressing force of the pressure roll 53 to the forming resin Dx, the forming resin Dx is compression bonded to the die forming face of the second belt 44, and the optical elements OE2 corresponding to the forming die of the second belt 44 are formed on the surface of the forming resin Dx.

<Stacking Process P14>

The stacking process P14 is a process that stacks the forming resin Cx on the face of the forming resin Dx on the opposite side of the face on which the optical elements OE2 are formed. That is, the forming resin Cx is delivered from the sheet supply reel RT2, and the forming resin Cx is supplied between the second belt 44 and the pressure roll 52. The forming resin Cx is stacked on the surface of the forming resin Dx delivered out of the pressure roll 53 being attached to the die forming face of the second belt 44 by conveying the forming resin Cx in the traveling direction of the second belt 44. At this time, the face of the forming resin Dx on the opposite side of the face, on which the optical elements OE2 are formed, is compression bonded to one face of the forming resin Cx by applying the pressing force of the pressure roll 52, and the forming resin Cx is integrated with the forming resin Dx.

<Second Embossing Process P15>

The second embossing process P15 is a process that sandwiches the forming resins Bx to Dx between the first belt 34 and the second belt 44, again presses the die forming face of the first belt 34 to the surface of the forming resin Bx, and again presses the die forming face of the second belt 44 to the surface of the forming resin Dx.

That is, the forming resin Bx through the first embossing process P13 is supplied between the first heating roll 31 and the second heating roll 41 being attached to the die forming face of the first belt 34 by moving the first belt 34 in the traveling direction. The forming resins Cx and Dx through the stacking process P14 are supplied between the first heating roll 31 and the second heating roll 41 by moving the second belt 44 in the traveling direction with the forming resin Dx being attached to the die forming face of the second belt 44.

The forming resins Bx to Dx supplied between the first heating roll 31 and the second heating roll 41 are sandwiched by the first belt 34 and the second belt 44. At this time, the die forming face of the first belt 34 is again pressed to the surface of the forming resin Bx, and the die forming face of the second belt 44 is again pressed to the surface of the forming resin Dx.

In the forming resins Cx and Dx already integrated with each other in the stacking process P14, the surface on the forming resin Cx side is compression bonded to the face of the forming resin Bx on the opposite side of the face on which the optical elements OE1 are formed. Thus, all the forming resins Bx to Dx are integrated with each other.

<Cooling Process P16>

The cooling process P16 is a process that cools the forming resins Bx to Dx integrated with each other through the second embossing process P15. That is, the forming resins Bx to Dx are conveyed being sandwiched by the first belt 34 and the second belt 44 to the subsequent stage by moving the first belt 34 and the second belt 44 in the traveling direction.

Specifically, the forming resins Bx to Dx are conveyed to the belt portion where the second belt 44 is in contact with the second chill roll 42, and cooled from the second belt 44 side by the second chill roll 42.

Subsequently, the forming resins Bx to Dx are conveyed to the belt portion where the first belt 34 is in contact with the first chill roll 32, and cooled from the first belt 34 side by the first chill roll 32.

<Releasing Process P17>

In the releasing process P17, the forming resins Bx to Dx sandwiched by the first belt 34 and the second belt 44 are released from one of the first belt 34 and the second belt 44. In the embodiment, in the forming resins Bx to Dx integrated with each other through the second embossing process P15, the forming resin Dx side is released from the surface of the second belt 44, and the forming resins Bx to Dx are conveyed being attached to the surface of the first belt 34 toward the release roll 45. The forming resins Bx to Dx are released from the surface of the second belt 44 by the release roll 45, and wounded on the reel, not shown. After that, the forming resins Bx to Dx are subjected to subsequent processing, such as cutting, and then the optical sheet E as illustrated in FIG. 5 is obtained.

As described above, in the embodiment, the first heating roll 31, the first chill roll 32, and the first belt 34 of the first transfer unit 3 and the second heating roll 41, the second chill roll 42, and the second belt 44 of the second transfer unit 4 are disposed as with the first embodiment.

Therefore, as with the case of the first embodiment described above, the displacement of the relative position between the belt portions of the first heating roll 31 and the second chill roll 42 can be reduced. Consequently, as with the first embodiment, the embodiment can obtain an optical sheet with parameters much closer to design values.

In the case of the embodiment, the forming resin Bx is supplied between the pressure roll 51 that presses a predetermined region of the belt portion of the first belt 34 in contact with the first heating roll 31 and the first belt 34, and the optical elements OE1 corresponding to the forming die of the first belt 34 are formed on the surface of the forming resin Bx. The forming resin Dx is supplied between the pressure roll 53 that presses a predetermined region of the belt portion of the second belt 44 in contact with the second heating roll 41 and the second belt 44, and the optical elements OE2 corresponding to the forming die of the second belt 44 are formed on the surface of the forming resin Dx.

After that, the forming resins Bx and Dx are supplied between the first heating roll 31 and the second heating roll 41 being sandwiched between the first belt 34 and the second belt 44, and the forming die is again pressed to the forming resins Bx and Dx by applying the pressing force of these heating rolls.

As described in the embodiment, the sites where the forming die is pressed to the surface of the forming resins Bx and Dx are two sites. When the forming resins Bx and Dx are moved from one site to the other site, the forming resins Bx and Dx are sandwiched by the first belt 34 and the second belt 44. Therefore, in the case of the embodiment, the transferability of the forming die to the forming resins Bx and Dx can be improved, compared with the case of the first embodiment.

In the case of the embodiment, the forming resins Bx to Dx conveyed to the second belt portion in contact with the second chill roll 42 are released from the surface of the second belt 44, and conveyed being attached to the surface of the first belt 34 to the subsequent stage.

Consequently, the cooling period by the first chill roll 32 can be prolonged, compared with the first embodiment in which the forming resin Ax conveyed to the second belt portion in contact with the second chill roll 42 is released from the surface of the first belt 34 and is conveyed begin attached to the surface of the second belt to the subsequent stage. Accordingly, the forming resins Bx to Dx can be easily released from the release roll 45, compared with the first embodiment.

### (3) Other Embodiments

As described above, the first and the second embodiments are described as examples. However, the present invention is not limited to the foregoing embodiments.

For example, in the first embodiment, the optical elements OE with irregularities are formed on one surface of the optical sheet A. However, optical elements with irregularities may be formed also on the other face on the opposite side of one surface of the optical sheet A. Note that, in the case in which the optical elements with irregularities are formed on the other face of the optical sheet A, the shape and size of the optical elements may be the same as or different from the shape and size of the optical elements OE formed on one surface of the optical sheet A. In the case in which the optical elements with irregularities are formed on the other face of the optical sheet A, the forming die for the optical elements with irregularities is formed on the surface of the second belt 44.

Note that, in the case in which both the forming die formed on the first belt 34 and the forming die formed on the second belt 44 are forming dies with irregularities, the height difference of the irregularities of the first belt 34 is preferably smaller than the height difference of the irregularities of the second belt 44. In the case in which such height differences are provided, in the first belt 34 and the second belt 44, the height difference of the irregularities of the first belt 34 from which the forming resin Ax is released is smaller than the irregularities of the second belt 44 from which the forming resin Ax is not released. Thus, the forming resin Ax can be easily released from the surface of the first belt 34, compared with the case in which the height differences of the irregularities of the first belt 34 and the second belt 44 are almost the same.

In the first embodiment, the surface temperature of the first chill roll 32 is preferably lower than the surface temperature of the second chill roll 42. In the case of providing this configuration, in the first chill roll 32 and the second chill roll 42, the surface temperature of the first chill roll 32, at which the forming resin Ax is released from the belt, is lower than the surface temperature of the second chill roll 42, at which the forming resin Ax is not released from the belt. Thus, the surface of the first belt 34, from which the forming resin Ax has to be released, can be quickly cooled, and the forming resin Ax can be easily released from the surface of the first belt 34, compared with the case in which the surface temperatures of the first chill roll 32 and the second chill roll 42 are almost the same.

In the first embodiment, the surface temperature of the first heating roll 31 is preferably lower than the surface temperature of the second heating roll 41. In the case of providing this configuration, in the first heating roll 31 and the second heating roll 41, the surface temperature of the first heating roll 31 near to the chill rolls 32 and 42 is lower than the surface temperature of the second heating roll 41 far from the chill rolls 32 and 42. Thus, the surface of the first belt 34 in contact with the first heating roll 31 can be quickly cooled by the chill rolls 32 and 42 in the subsequent stage, and the forming resin Ax can be easily released from the surface of the first belt 34, compared with the case in which the surface temperatures of the first heating roll 31 and the second heating roll 41 are almost the same.

In the second embodiment, the optical elements OE with irregularities are formed on the surface of the first optical layer B on the opposite side of the face opposed to the second optical layer C and the surface of the third optical layer D on the opposite side of the face opposed to the second optical layer C. However, the optical elements OE formed on the first optical layer B or the third optical layer D may be omitted. Note that, in the case in which the optical elements OE formed on the first optical layer B or the third optical layer D are omitted, the surface of the first belt 34 or the second belt 44 is the forming die for flat optical elements with no irregularities.

Note that, in the case in which both the forming die formed on the first belt 34 and the forming die formed on the second belt 44 are forming dies with irregularities, the height difference of the irregularities of the first belt 34 is preferably greater than the height difference of the irregularities of the second belt 44. In the case in which such height differences are provided, in the first belt 34 and the second belt 44, the height difference of the irregularities of the second belt 44, from which the forming resins Bx to Dx is released, is smaller than the irregularities of the first belt 34, from which the forming resins Bx to Dx is not released. Thus, the forming resins Bx to Dx can be easily released from the surface of the second belt 44, compared with the case in which the height differences of the first belt 34 and the irregularities of the second belt 44 are almost the same.

In the second embodiment, the surface temperature of the first chill roll 32 is preferably higher than the surface temperature of the second chill roll 42. In the case of providing this configuration, in the first chill roll 32 and the second chill roll 42, the surface temperature of the second chill roll 42, at which the forming resins Bx to Dx is released from the belt, is lower than the surface temperature of the first chill roll 32, at which the forming resins Bx to Dx is not released from the belt. Thus, the surface of the second belt 44, from which the forming resins Bx to Dx have to be released, can be quickly cooled, and the forming resins Bx to Dx can be easily released from the surface of the second belt 44, compared with the case in which the surface temperatures of the first chill roll 32 and the second chill roll 42 are almost the same.

As with the case of the first embodiment, in the second embodiment, the surface temperature of the first heating roll 31 is preferably lower than the surface temperature of the second heating roll 41. In the case of providing this configuration, as described above, the surface of the first belt 34 in contact with the first heating roll 31 can be quickly cooled by the chill rolls 32 and 42 in the subsequent stage, and the forming resins Bx to Dx can be easily released from the surface of the first belt 34, compared with the case in which the surface temperatures of the first heating roll 31 and the second heating roll 41 are almost the same.

In the first and the second embodiments, the second chill roll 42 is disposed pressing the first chill roll 32 in turn through the second belt 44, the forming resin, and the first belt 34. As described above, in such a disposition state, the first chill roll 32 faces the second chill roll 42 at positions closest to each other sandwiching the second belt 44, the forming resin Ax, and the first belt 34. Thus, there is no section with non-contact portions in which the first belt 34 or the second belt 44 conveyed between the first chill roll 32 and the second chill roll 42 is in contact with neither the chill rolls 32 nor 42.

However, the first chill roll 32 may be separated from the second chill roll 42 so that this section with the non-contact portions is present. In such a disposition state, the first chill roll 32 does not face the second chill roll 42 at positions closest to each other sandwiching the second belt 44, the forming resin Ax, and the first belt 34.

In the first and the second embodiments, the first heating roll 31 is disposed pressing the second chill roll 42 through the first belt 34, the forming resin, and the second belt 44. However, the first heating roll 31 may be disposed not pressing the second chill roll 42 through the first belt 34, the forming resin, and the second belt 44. That is, the first belt 34 and the second belt 44 conveyed between the first heating roll 31 and the second chill roll 42 may have a roll non-contact belt section in which the first belt 34 and the second belt 44 are in contact with neither the first heating roll 31 nor the second chill roll 42.

In this case, from the viewpoint of preventing the displacement of the relative position between the first belt 34 and the second belt 44, the distance (the length) of the roll non-contact belt section is preferably not greater than a half of the distance (the length) of the first belt non-contact portion PT1 or the distance (the length) of the second belt non-contact portion PT2. With this configuration, the displacement of the relative position between the first belt and the second belt can be reduced, and the optical sheet A with parameters much closer to design values can be obtained.

In the first and the second embodiments, the second transfer unit 4 is fixed, and the first transfer unit 3 is movable in the direction D1 in which the first transfer unit 3 is apart from the second transfer unit 4 and in the direction D2 in which the first transfer unit 3 approaches the second transfer unit 4. However, such a configuration may be possible in which the first transfer unit 3 is fixed and the second transfer unit 4 is movable in the direction in which the second transfer unit 4 is apart from the first transfer unit 3 and in the direction in which the second transfer unit 4 approaches the first transfer unit 3. Such a configuration may be possible in which both of the first and the second transfer units 3 and 4 are movable in the direction in which they are apart from each other and in the direction in which they approach each other. Alternatively, both of the first and the second transfer units 3 and 4 may be fixed.

Note that, the components of the manufacturing device and the manufacturing method for an optical sheet can be appropriately combined, omitted, modified, added with known techniques, and so on within the scope not deviating from the object of the present application, in addition to the content shown in the foregoing embodiments.

The present invention is applicable in the case of manufacturing optical sheets.

### REFERENCE SIGNS LIST

1 . . . manufacturing device for an optical sheet
2 . . . resin supply unit
3 . . . first transfer unit
4 . . . second transfer unit
31 . . . first heating roll
32 . . . first chill roll
33 . . . first extension roll
34 . . . first belt
41 . . . second heating roll
42 . . . second chill roll
43 . . . second extension roll
44 . . . second belt
45 . . . release roll
51 to 53 . . . pressure roll

1. A manufacturing device for an optical sheet comprising:
a first belt having a surface formed with a forming die in a predetermined shape, the first belt extending on a first heating roll and a first chill roll, the first belt being moved corresponding to rotation of the first heating roll and the first chill roll; and
a second belt having a surface formed with a forming die in a predetermined shape, the second belt extending on a second heating roll and a second chill roll, the second belt being moved corresponding to rotation of the second heating roll and the second chill roll, wherein:
the first heating roll is disposed opposed to the second heating roll;
the first chill roll is disposed opposed to the second chill roll;
the first belt is disposed opposed to the second belt so that a surface of the first belt faces a surface of the second belt;
the first heating roll is disposed pressing, from the surface of the second belt, a second belt non-contact portion that is a belt portion of the second belt facing the first belt where the second heating roll and the second chill roll are not in contact with the second belt;
the second belt non-contact portion meanders along the first heating roll so as to bend to center sides of the second heating roll and the second chill roll from a tangential plane between the second heating roll and the second chill roll;
the second chill roll is disposed pressing, from the surface of the first belt, a first belt non-contact portion that is a belt portion of the first belt facing the second belt where the first heating roll and the first chill roll are not in contact with the first belt;
the first belt non-contact portion meanders along the second chill roll so as to bend to center sides of the first heating roll and the first chill roll from a tangential plane between the first heating roll and the first chill roll; and
a forming resin is supplied between a surface of a belt portion of the first belt where the first belt is in contact with the first heating roll and a surface of a belt portion of the second belt where the second belt is in contact with the second heating roll, pressed by the two surfaces, and conveyed being sandwiched by the first belt and the second belt to a subsequent stage.

2. The manufacturing device for an optical sheet according to claim 1, wherein
the forming resin conveyed to the subsequent stage is conveyed to a belt portion of the second belt where the second belt is in contact with the second chill roll, cooled, released from the surface of the first belt, and conveyed being attached to the surface of the second belt to a subsequent stage.

3. The manufacturing device for an optical sheet according to claim 1, wherein
the second chill roll is disposed pressing the first chill roll through the second belt, the forming resin, and the first belt.

4. The manufacturing device for an optical sheet according to claim 1, wherein
the first heating roll is disposed pressing the second chill roll through the first belt, the forming resin, and the second belt.

5. The manufacturing device for an optical sheet according to claim 1, wherein
a surface temperature of the first heating roll is lower than a surface temperature of the second heating roll.

6. The manufacturing device for an optical sheet according to claim 2, wherein
a surface temperature of the first chill roll is lower than a surface temperature of the second chill roll.

7. The manufacturing device for an optical sheet according to claim 2, wherein:
the forming die on the surface of the first belt is in a flat shape or irregular shape, and the forming die on the surface of the second belt is in an irregular shape; and
a height difference of irregularities of the first belt is smaller than a height difference of irregularities of the second belt.

8. A manufacturing method for an optical sheet comprising:
a resin supplying process of supplying a forming resin between a first belt and a second belt, the first belt extending on a first heating roll and a first chill roll, the first belt being moved corresponding to rotation of the first heating roll and the first chill roll, the second belt extending on a second heating roll facing the first heating roll and a second chill roll facing the first chill roll, the second belt being moved corresponding to rotation of the second heating roll and the second chill roll;
an embossing process of softening the forming resin using the first heating roll and the second heating roll and forming optical elements on the forming resin using a forming die formed on a surface of the first belt and a forming die formed on a surface of the second belt; and
a cooling process of cooling the forming resin formed with the optical elements using the first chill roll and the second chill roll, wherein:
the first heating roll is disposed pressing, from the surface of the second belt, a second belt non-contact portion that is a belt portion of the second belt facing the first belt where the second heating roll and the second chill roll are not in contact with the second belt;
the second belt non-contact portion meanders along the first heating roll so as to bend to center sides of the second heating roll and the second chill roll from a tangential plane between the second heating roll and the second chill roll;
the second chill roll is disposed pressing, from the surface of the first belt, a first belt non-contact portion that is a belt portion of the first belt facing the second belt where the first heating roll and the first chill roll are not in contact with the first belt;
the first belt non-contact portion meanders along the second chill roll so as to bend to center sides of the first heating roll and the first chill roll from a tangential plane between the first heating roll and the first chill roll; and
a forming resin is supplied between a surface of a belt portion of the first belt where the first belt is in contact with the first heating roll and a surface of a belt portion of the second belt where the second belt is in contact with the second heating roll, pressed by the two surfaces, and conveyed being sandwiched by the first belt and the second belt to a subsequent stage.

9. The manufacturing method for an optical sheet according to claim 8, wherein
the forming resin conveyed to the subsequent stage is conveyed to a belt portion of the second belt where the second belt is in contact with the second chill roll, cooled, released from the surface of the first belt, and conveyed being attached to the surface of the second belt to a subsequent stage.

10. The manufacturing method for an optical sheet according to claim 8, wherein
the second chill roll is disposed pressing the first chill roll through the second belt, the forming resin, and the first belt.

11. The manufacturing method for an optical sheet according to claim 8, wherein
the first heating roll is disposed pressing the second chill roll through the first belt, the forming resin, and the second belt.

12. The manufacturing method for an optical sheet according to claim 8, wherein
a surface temperature of the first heating roll is lower than a surface temperature of the second heating roll.

13. The manufacturing method for an optical sheet according to claim 9, wherein
a surface temperature of the first chill roll is lower than a surface temperature of the second chill roll.

14. The manufacturing method for an optical sheet according to claim 9, wherein:
the forming die on the surface of the first belt is in a flat shape or irregular shape, and the forming die on the surface of the second belt is in an irregular shape; and
a height difference of irregularities of the first belt is smaller than a height difference of irregularities of the second belt.
